(19) United States
(12) Patent Application Publication
(10) Pub. No.: US 2007/0115883 A1
(43) Pub. Date: May 24, 2007

(54) Method for reducing hand-off latency in mobile networks

(75) Inventors: Sathya R. Narayanan, Plainsboro, NJ (US); Rajesh B. Khandelwal, Bridgewater, NJ (US)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 10/564,112

(22) PCT Filed: Jul. 14, 2004
(86) PCT No.: PCT/US04/22474

§ 371 Date: Jul. 28, 2006

Related U.S. Application Data
(60) Provisional application No. 60/487,019, filed on Jul. 14, 2003.

(51) Int. Cl. H04Q 7/00

(52) U.S. Cl. 370/331

(57) ABSTRACT

A method for use in a mobile device to expedite hand-off of mobile devices between access points first detects movement of the mobile device among the coverage ranges of the access points. A mobile device that moves from one access point to another periodically transmits information on the data link level connection of its new access point on the channel used to access its prior access point. A first mobile device that is coupled to access points in a particular area maintains network level access information for access points with which it has communicated. When a new mobile device enters the area, the first device detects the new device and transmits the list to the new mobile device, enabling the new device to connect to an access point without transmitting a router solicitation message or receiving a router advertisement message.

The present invention claims benefit of priority from U.S. Provisional Application No. 60/487,019 filed Jul. 14, 2003, the contents of which are incorporated herein by reference.

### BACKGROUND OF THE INVENTION

The present invention concerns mobile networks and, in particular, a method for reduced latency network connection hand-offs.

In mobile networks, a mobile device such as a portable computer with a wireless local area network (WLAN) connection may connect to a network (e.g. the Internet) through a stationary access point. When the mobile device is moved, however, it may move to a location that is out of the range of its existing access point but within range of a new access point. Therefore, to prevent loss of connection to the network, the mobile device is “handed-off” from the old access point to the new. This hand-off occurs both on level 2 (i.e. the data link layer) and level 3 (i.e. the network layer) of the open system interconnect (OSI) network model. During the hand-off process, the mobile device may not be able to send and receive data packets until both the level 2 and level 3 connections are resolved with the new access point and router. This handoff latency is undesirable and may even prevent certain applications (e.g. voice over IP, streaming media, and real-time applications) from running due to the relatively long latency and consequent interruption of data flow between the mobile device and the network.

At level 2, the mobile device probes the new access point to identify a channel that it may use to communicate with the access point. Typically, wireless channels correspond to predetermined frequency bands that are defined depending on the communications protocol being used (e.g., 802.11). Because a mobile device may try several channels before finding one on which it can communicate with the new access point, the latency due to establishing a level 2 connection alone may be as much as 400-500 ms.

Once a level 2 connection is established, the mobile device may then configure itself i.e., at the network level, level 3) with parameters appropriate for the new access router. This is typically done by having the mobile device send a router solicitation message in its new environment. When the router receives the router solicitation message, it responds with a router advertisement message. This message is not sent immediately upon receipt of the router solicitation message but is sent with a random delay to prevent flooding that may occur when multiple routers communicate on the same channel. The router solicitation message and router advertisement message are described in Internet Request for Comments (RFC) 2461 entitled “Neighbor Discovery for IP Version 6 (IPv6).”

As an alternative to sending a router solicitation message, the mobile device may wait to receive a router advertisement message which is transmitted periodically by the router via one or more access points. The minimum time between sending these periodic router advertisement messages, however, may be a few seconds. Thus, the total latency to establish a connection after a hand-off may be in the range of one to four seconds.

Decreasing the minimum time between periodically transmitted router advertisement messages may decrease this latency to a certain extent, but it may also undesirably increase the data traffic in the communication channel. This problem is most evident in “hot spots,” for example, airport terminals or other public venues where hand-off traffic is likely to be relatively significant. In addition, decreasing the time between router advertisement messages or between a router solicitation message and its corresponding router advertisement message leaves the network open to denial of service (DoS) attacks, in which a malicious mobile device floods the router with router solicitation messages.

### SUMMARY OF THE INVENTION

The present invention is embodied in a method for expediting hand-off of mobile devices among access points and access routers. According to this method, a mobile device that moves from one access point to another periodically transmits information on the level 2 connection of its previous access point on the channel used to access its current access point. Devices connected to the current access point receive this message and can use this information to immediately establish a level 2 connection with the prior access point without probing when they move out of the current access points coverage area.

the present invention is also embodied in a method for expediting hand-off of mobile devices between access points. According to this method, a mobile device that moves from one access point to another periodically transmits information on the level 2 connection of its new access point on the channel used to access its prior access point. Devices connected to the prior access point receive this message and can use this information to immediately establish a level 2 connection with the new access point without probing when they move out of the coverage area of their access point.

According to another aspect of the invention, a first mobile device that is coupled to access router in a particular area maintains network layer connection information for access routers with which it has communicated. When a new mobile device enters the area, the first device detects the new device and transmits the list, enabling the new device to connect to an access router without transmitting a router solicitation message or receiving a router advertisement message.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a block diagram that illustrates an environment in which one embodiment present invention may be used;

FIG. 2 is a block diagram that illustrates an environment and scenario in which another embodiment of the present invention may be used;

FIG. 3 is a block diagram that illustrates an environment and scenario in which a further embodiment of the present invention may be used;

FIGS. 4A, 4B, and 4C are exemplary priority lists of stored connection information according to an embodiment of the present invention;

FIGS. 5A and 5B are flow-chart diagrams that are useful for describing the establishment of a level 2 connection according to one embodiment of the present invention;

FIGS. 6A and 6B are flow-chart diagrams that are useful for describing the establishment of a level 2 connection according to another embodiment of the present invention; and

FIG. 7 is a flow-chart diagram that is useful for describing the establishment of a level 3 connection according to an embodiment of the present invention.

### DETAILED DESCRIPTION OF THE INVENTION

One embodiment of the present invention is a method by which mobile devices connected to a wireless network comprised of a plurality of wireless access points and routers may communicate and share channel and network connection information without depending on the network so as to reduce latency in the hand-off of one mobile device from a first wireless access point and/or router to another.

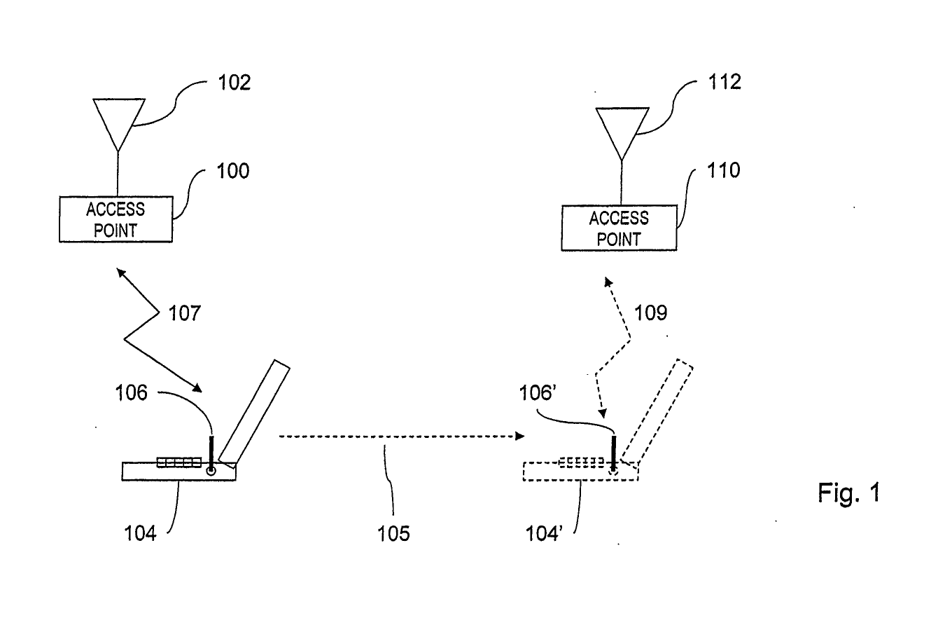

Referring now to the drawing, in which like reference numbers refer to like elements throughout the various figures that comprise the drawing, FIG. 1 is a block diagram which illustrates an exemplary problem that may be addressed by one embodiment of the present invention. FIG. 1 shows access point 100 having an antenna 102 and a portable computer (mobile device) 104 having an antenna 106. Both the mobile device 104 and the access point 100 include hardware and software elements that implement a wireless local area network connection 107 between the two devices. In an exemplary embodiment of the invention, these may be, for example, circuitry and software that conform to the IEEE 802.11 wireless networking standard.

In the exemplary embodiment shown in FIG. 1, mobile device 104 has established the wireless connection 107 with the access point 100 and may be accessing a global information network (e.g. the Internet) through this connection. While the connection is established, mobile device 104 is moved as indicated by the arrow 105. The mobile device in its moved position is indicated as 104′ and its antenna as 106′. In its new position, the device 104′ no longer has a reliable connection to the access point 100. It is, however, within the coverage area of a second access point, 110.

To continue the Internet session, the mobile device 104′ establishes a connection 109 with access point 110 through antenna 106′ and antenna 112. As described above, the connection is established at both the data link level (level 2) with the access point and network level (level 3) with an access router, using the notation of the OSI model.

As described in an article by A. Mishra et al. entitled “An Empirical Analysis of the IEEE 802.11 MAC Layer Handoff Process,” establishment of a level 2 connection is typically performed by having the mobile device send probe messages to the new access point. Each probe message may, for example, be at a different frequency or according to a different channel protocol. When the mobile device receives a response to a probe message, it knows the channel information from the successful probe and, using this information, establishes a data link connection with the new access point. As described above, the time used in repeatedly probing the access point and responding to the probe may introduce an undesirable delay in the establishment of a new connection. This delay, combined with the delay in establishing a level 3 connection may result in a total delay of several seconds. A delay of this magnitude is at least an annoyance during an internet session and may result in undesirable performance of real-time and streaming applications.

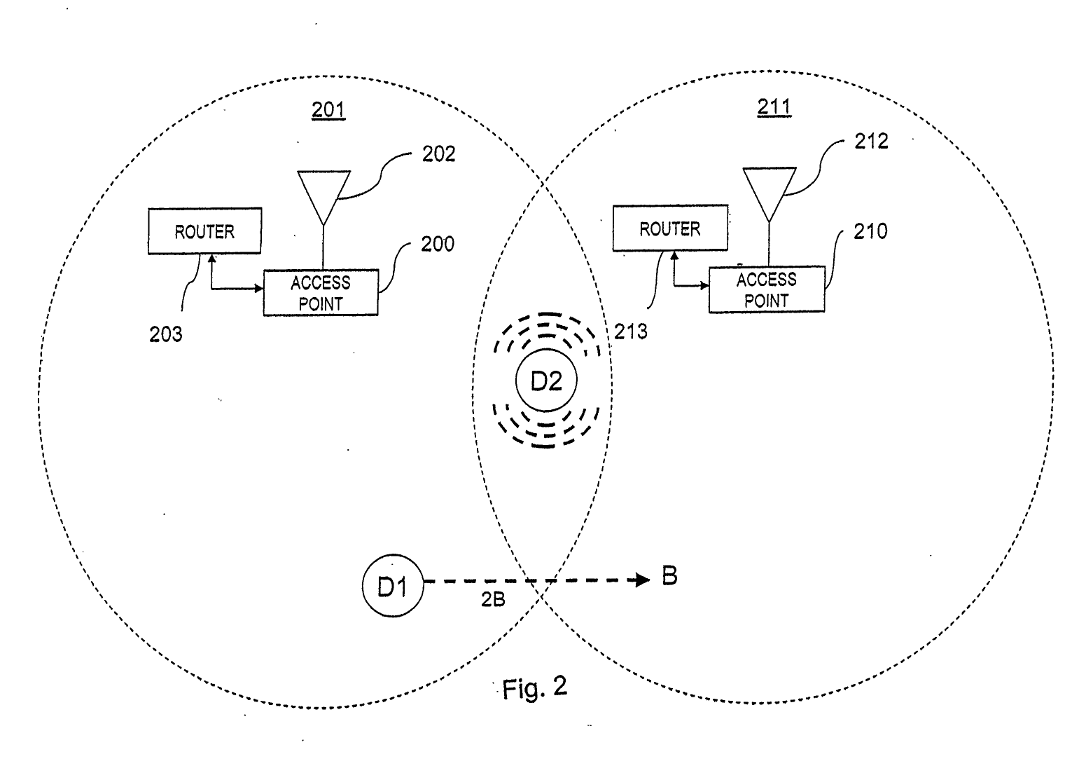

In one embodiment of the present invention, an alternative to the method described above for establishing a level 2 connection may desirably reduce the delays in mobile device hand-off. Such an embodiment may be described with respect to the block diagram in FIG. 2, which illustrates mobile device D1 connected to the wireless network through router 203 and access point 200 having antenna 202 and coverage range 201 (shown in phantom). Mobile device D2 was previously connected to the wireless network through access point 200, but is currently connected through router 213 and access point 210 having antenna 212 and coverage range 211 (shown in phantom). According to one embodiment of the invention, mobile device D2 stores the level 2 connection information for the channel used in its connection to access point 200 and level 3 configuration information for router 203. While connected to access point 210 and router 213, mobile device D2 may periodically transmit (shown as concentric circles in phantom) the stored level 2 connection information and level 3 configuration information through the channel used to connect to access point 210. Those skilled in the art will recognize that mobile device D2 is not restricted to being within coverage range 211 to do this. Accordingly, any mobile devices that are listening on or connected to the channel used to connect to access point 210 may detect and store the level 2 connection information and level 3 configuration information for the channel used to connect to access point 200.

In an alternate embodiment, mobile device D1 and mobile device D2 may both be connected to access point 200, where mobile device D2 was previously connected to access point 210 and has, therefore, stored the connection information for access point 200. While connected to access point 200 and router 203, mobile device D2 may then periodically transmit (shown as concentric circles in phantom) the connection information and router configuration information for its current connection to access point 200 and router 203 over the channel it previously used in its connection to access point 210. Accordingly, any mobile devices that are on a connection with access point 210 (including mobile device D1) may detect and store the connection information about access point 200 and configuration information for router 203.

Therefore, if mobile device D1 moves along path 2B outside of the coverage range 201 of access point 200 to point B within the coverage range 211 of access point 210, then mobile device D1 will be able to immediately initiate a connection with access point 210 and router 213 using the stored level 2 connection information and level 3 configuration information.

In a further embodiment, once mobile device D1 has made the new connection to access point 210 and router 213, it may store and periodically transmit the connection information for access point 210 and configuration data for the router 213 over the channel used for its previous connection to access point 200. Alternately, It may store and periodically transmit the connection information for access point 200 and configuration information for router 203 over the channel used for its current connection to access point 210.

A mobile device may detect movement along path 2B leading out of coverage range 201 of current access point 200 may be performed by monitoring the signal strength of communications with current access point 200. If signal strength falls below a predetermined threshold value, then mobile device D1 may attempt to initiate a connection with new access point 210 for a better signal. Movement outside of coverage range 201 may also be characterized by communications failure such as excessive communications timeouts and too many retries, for example. Those skilled in the art will recognize that there are other methods of detecting and characterizing signal failure as well.

Alternatively, or in addition, the access point may include global positioning system (GPS) data indicating its position and each mobile device may include a GPS receiver to continually calculate its position. The mobile device may then connect to the access point that is closest to it by analyzing its own position versus the position information received from the various access points. The GPS data may be monitored over time to determine a direction of travel for the mobile device. This direction may be used to identify a next access point if the mobile device includes stored data for more than one access point.

Additionally, there may exist regions where coverage range overlap may lead to mobile device D1 attempting to switch back and forth repeatedly from access point 200 to access point 210. One embodiment of the invention corrects this with any one of the many known methods of control systems hysteresis, such as the double-valued response used in a typical thermostat, for example.

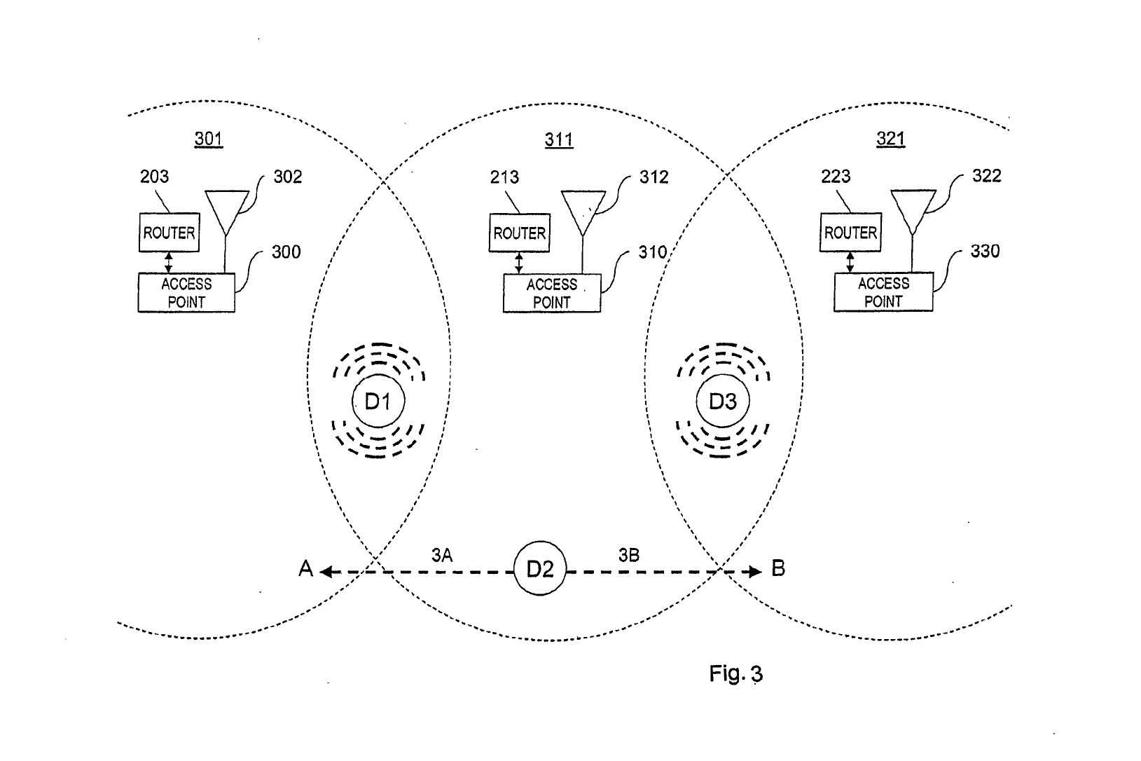

FIG. 3 Is a block diagram that illustrates another exemplary implementation of the present invention. Mobile device D2 is connected to the wireless network through router 213, access point 310 having antenna 312 and coverage range 311 (shown in phantom). Mobile device D1 was previously connected to the wireless network through router 213 and access point 310, but is currently connected through access point 300 having antenna 302 and coverage range 301 (shown in phantom). Additionally, mobile device D3 was also previously connected to the wireless network through router 213 access point 310, but is currently connected through router 223 and access point 330 having antenna 322 and coverage range 321 (shown in phantom).

According to one embodiment of the invention, mobile devices D1 and D3 store the level 2 connection information for the channel used in their respective connections to access points 300 and 330 and configuration information for their respective routers 203 and 223. While connected to access point 310, mobile device D1 may periodically transmit (as shown by concentric circles in phantom) this stored level 2 connection information and level 3 configuration data through its current channel. Those skilled in the art will recognize that mobile device D1 is not restricted to being within coverage range 311 to do this. Mobile device D3 performs in substantially the same way as described above, and, therefore, any mobile devices that are listening on or connected to the channel used to connect to access point 310 detect and store the level 2 connection information and level 3 configuration information for the respective channels used to connect to the access point 300 and router 203 and the access point 330 and router 223.

In an alternate embodiment, mobile devices D1, D2, and D3 may all be connected to router 213 and access point 310, where mobile device D1 was previously connected to router 203 and access point 300 and has stored the connection information for access point 300 and configuration data for router 203. In this example, mobile device D3 was previously connected to router 223 and access point 330 and has stored the connection information and configuration for the access point and router. While connected to access point 310, mobile devices D1 and D3 may then periodically switch from the channel used in its connection to access point 310 to the channels used for their respective previous access points. With each periodic channel switch, mobile device D2 may transmit (shown as concentric circles in phantom) the connection information and configuration data for their respective current connections to access point 310 and router 213 over the channels used in their previous connections to access points 300 and 320. Accordingly, any mobile devices that are on a connection with access point 300 and 320 may detect and store the connection information and configuration data for access point 310 and router 213.

Therefore, if mobile device D2 moves along path 3A outside of access point 310 coverage range 311 to point A within the coverage area of access point 300, then it will be able to immediately initiate a connection with access point 300 and router 203 using the stored level 2 connection information and level 3 configuration data for such a connection. Similarly, if mobile device D2 moves along path 3B to point B, it may immediately initiate a connection with access point 330 and configure itself for router 223.

In a further embodiment, once mobile device D2 has made the new connection to one of access points 300 and 330 and one of the routers 203 and 223, it may store and periodically transmit the level 2 connection information and level 3 configuration data for its new connection to one of access points 300 and 330 over the channel used for its previous connection to access point 310. Alternately, it may store and periodically transmit the level 2 connection information for access point 310 and level 3 configuration data for router 213 over the channel used for its new connection to one of access points 300 and 330.

In FIG. 3, movement of mobile device D2 along one of paths 3A and 3B may result in a loss of or at least a weaker signal between mobile device D2 and access point 310. Consequently, mobile device D2 may initiate a new connection with one of access points 300 and 330 in order to obtain a stronger connection.

Mobile device D2 may detect its movement and consequent loss of signal strength along one of paths 3A and 3B leading out of coverage range 311 of current access point 310 by monitoring the strength of its communications signal with current access point 310. If signal strength falls below a predetermined threshold value, then mobile device D2 may attempt to initiate a connection with one of access points 300 and 330 for a better signal as described above. Movement outside of coverage range 311 may also be characterized by communications failure such as excessive communications timeouts and too many retries, for example. Those skilled in the art will recognize that there are other methods of detecting and characterizing signal failure as well.

Additionally, there may exist regions where coverage range overlap may lead to mobile device D2 attempting to switch back and forth repeatedly between access point 311 and one of access points 300 and 330. One embodiment of the invention may address this problem by implementing a detection of mobile device movement protocol including any one of the many known methods of control systems hysteresis, such as the double-valued response used in a typical thermostat, for example.

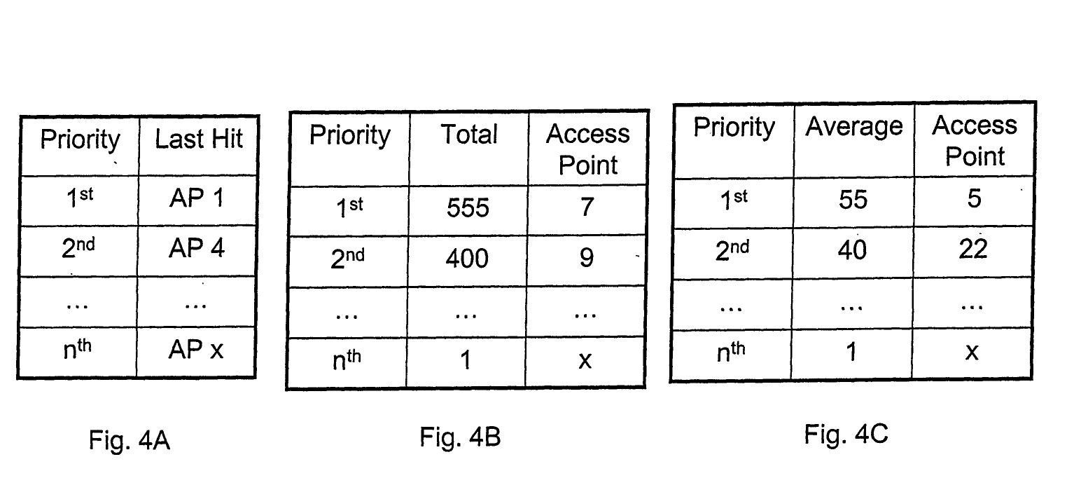

In one embodiment of the invention, mobile device D2 may determine which one of access points 300 and 330 to attempt to connect to first by maintaining a priority list of stored level 2 connection information and level 3 configuration data, and initiating a connection to the access point with the highest priority. According to separate exemplary embodiments of the invention, FIGS. 4A-C illustrate priority lists that may be used. In one embodiment, the table keeps a list of priorities from 1^{st} to n^{th} in order of the last received transmission. In FIG. 4A, for example, the last received (i.e., newest) transmission is about an access point designated as access point 1 (AP 1), which is given 1^{st} priority in the list; the second to last transmission is about access point 4 (AP 4), which is designated as having 2^{nd} priority; and the oldest transmission is about access point x (AP x), which is designated as having nth priority, where “n” can be any desirable number of priorities. Although illustrated as having at least 3 priority levels, the priority list may also be only a single level deep.

Alternatively or in addition, the priority list may be maintained based on the relative positions of the mobile device and the access points, based on their GPS data. In this exemplary embodiment the mobile device may continually recalculate its position using GPS data received from its GPS receiver (not shown) and, at the same time, recalculate the respective distances to the stored access points. In this embodiment, the closest access point at any given time would have the highest priority.

In a further embodiment of the invention, the table keeps a list of priorities from 1^{st} to n^{th} in order of the total number of transmissions received starting from any predetermined moment in time. In FIG. 4B, for example, connection information for access point 7 has been received 555 times, which is the most of any other access point. Consequently, access point 7 is given 1^{st} priority on the list. The second highest number of received transmission have been directed to connection information for access point 9, which is therefore given 2nd priority, and so on.

In yet another embodiment, the table keeps a list of averages or weighted averages from 1st to n^{th} priority in order of descending average. The average may be the number of transmissions of connection information received for a particular access point over a predetermined length of time, for example; it may also be the average signal strength of such transmissions received over a predetermined length of time; alternatively it may be a weighted product of the total number of such transmissions received and the average signal strength. In FIG. 4C, for example, connection information for access point 5 has the a priority average of 55, which is the most of any other access point and may indicate that connection information for access point 5 was received 55 times in the last minute, for example. Consequently, access point 5 is given 1st priority on the list. Access point 22 has a priority average of 40, for example, and is therefore given 2^{nd} priority, and so on. Those skilled in the art will recognize that there may be many desirable implementations of the average calculation as one of many possible equations, formulae, or algorithms that provide an indication of preference or priority, without departing from the spirit of the invention.

As described above, when a loss of signal strength is detected, a mobile device may initiate an attempt to connect to the access point whose connection information is stored at the top of the priority list. If the attempt to connect fails, then the mobile device may attempt to connect to the next device in the priority list, and may continue down the list until a desirable connection is established.

In an alternate embodiment, a mobile device that periodically transmits channel information for a connection to an access point and configuration data for a corresponding router may transmit the channel information and configuration data corresponding to the access point designated as having a first priority.

In another embodiment of the invention, mobile devices that periodically transmit channel information and configuration data for a connection to an access point and router may vary the power of their transmission, thereby making the transmission more locality specific. The power may be varied based on the known wireless transmitter parameters in order to obtain larger or smaller coverage ranges of the transmission as desired. Described with reference to FIG. 3, for example, it can be seen that if mobile device D2 were moving along path 3A, then it may be desirable to give 1^{st} priority to connection information for access point 300. By having mobile devices D1 and D3 lower the power of their transmissions, then mobile device D2 moving along path 3A, which is closer to mobile device D1, will receive stronger transmission from device D1 than device D3 (or may not receive the transmission from D3 at all). Accordingly, the priority list will designate connection information for access point 300 as having 1^{st} priority. Similarly, mobile device D2 moving along path 3B would have a priority list designating connection information for access point 330 as having 1^{st} priority. In this way, devices moving through the network are able to be kept substantially aware of their topology, whereby a more desirable priority list is maintained, allowing lower latency hand-offs.

It can be seen by those skilled in the art that in a system with a large number of mobile devices, signal collision and interference may introduce undesirable communications quality. Accordingly, collisions and interference may be addressed by the use of a known protocol such as the IEEE 802.11 Medium Access Control (MAC) protocol, which has built in controls to limit or prevent collisions and device interference. Such protocols may the implement Carrier Sense Multiple Access (CSMA) contention protocol or a variation thereof, for example.

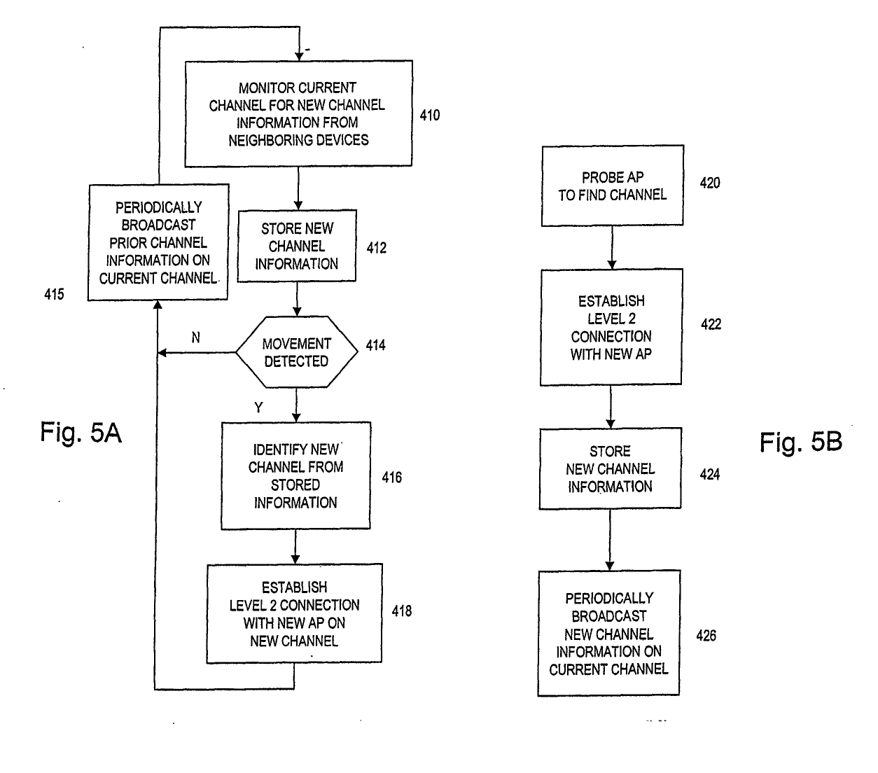

FIGS. 5A and 5B are flowcharts illustrating two embodiments of the present invention for establishing a level 2 connection that may greatly reduce hand-off latency. According to this method, each mobile device has limited communication directly with neighboring mobile devices. At step 410, the mobile device monitors its current channel for new channel information (i.e. data link level connection information) sent by neighboring devices. When new channel information is received, the mobile device stores the information at step 412. With reference to the block diagram of FIG. 1, in this step, mobile device 104 is monitoring the channel 107 that it has established with access point 100 for messages from another mobile device (not shown) that was previously connected to access point 110 but is now connected to access point 100. This other mobile device sends the data link layer information on a connection to access point 110 in the channel that it is currently using to communicate with access point 100.

At step 414, the mobile device detects movement. This may occur, for example, when the mobile device 104′ experiences a power reduction in its connection with access point 100. If movement is not detected at step 414, the device, if it previously moved from another access point, periodically transmits stored channel information for its prior channel over its current channel communications link, at step 415, and then transfers control to step 410, described above.

When movement is detected, however, control transfers to step 416, at which the stored information needed to establish a level 2 connection to access point 110 is retrieved. At step 418, this information is used to establish the data link connection between the mobile device 104′ and the access point 110. After step 418, control returns to step 410 which now monitors the newly established channel for channel information from neighboring devices.

The method described above assumes that there is already a neighboring device that has moved from having a connection with access point 110 to having a connection with access point 100. If, however, there is no other mobile device when mobile device 104 moves, the steps shown in FIG. 5B are executed. At step 420, mobile device 104′ probes access point 110, as described above to find a new channel. At step 422, device 104′ establishes connection 109 with access point 110. Device 104′ then stores the connection information for the new channel at step 424 and, at step 426, periodically transmits the new channel information to neighboring devices, using channel 109. In this way, other mobile devices (not shown) that are currently communicating with access point 110 can learn how to connect to access point 100 before they need to make the connection.

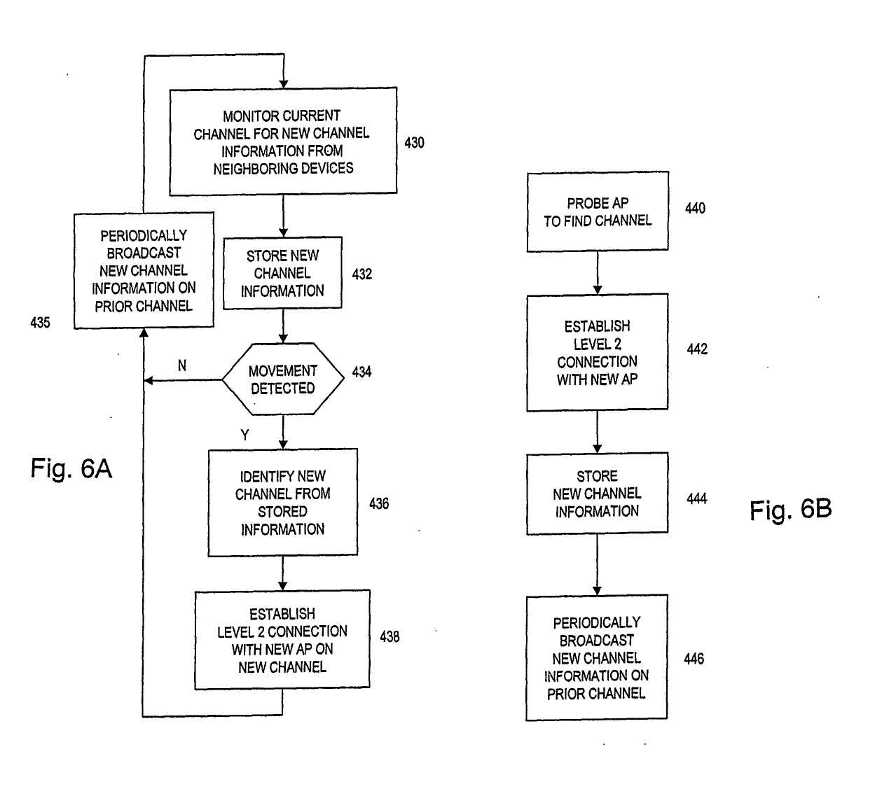

FIGS. 6A and 6B are flowcharts illustrating two alternative embodiments of the present invention for establishing a level 2 connection. This method operates similarly to the method described above with reference to FIGS. 5A and 5B except that the mobile device, upon establishing communications with its new access point periodically transmits the connection information for the new access point using the channel from its previous access point. With reference to the block diagram of FIG. 1, in this step, mobile device 104 is monitoring the channel 107 that it has established with access point 100 for messages from another mobile device (not shown) that has already connected to access point 110. This other mobile device sends the data link layer information on a connection to access point 110 in a channel used to communicate with access point 100 if found, this data is stored at step 432.

At step 434, the mobile device detects movement. This may occur, for example, when the mobile device 104′ experiences a power reduction in its connection with access point 100. If movement is not detected at step 434, the device, if it previously moved from another access point, periodically transmits stored channel information about its new channel over its prior channel communications link, at step 435, and then transfers control to step 430, described above.

When movement is detected, however, control transfers to step 436, at which the stored information needed to establish a level 2 connection to access point 110 is retrieved. At step 438, this information is used to establish the data link connection between the mobile device 104′ and the access point 110. After step 438, control returns to step 430 which now monitors the newly established channel for channel information from neighboring devices.

The method described above assumes that there is already a neighboring device that has moved from having a connection with access point 100 to having a connection with access point 110. If, however, there is no other mobile device when mobile device 104 moves, the steps shown in FIG. 6B are executed. At step 440, mobile device 104′ probes access point 110, as described above to find a new channel. At step 442, device 104′ establishes connection 109 with access point 110. Device 104′ then stores the connection information for the new channel at step 444 and, at step 446, periodically transmits the new channel information to neighboring devices, using channel 107. In this way, other mobile devices (not shown) that are currently communicating with access point 100 can learn how to connect to access point 110 before they need to make the connection.

In an alternate embodiment, device 104′ may store and periodically both transmit channel information for access point 100 over channel 109 and channel information for access point 110 over channel 107. Accordingly, when devices move, they can make the connection quickly using the stored parameters, as described above.

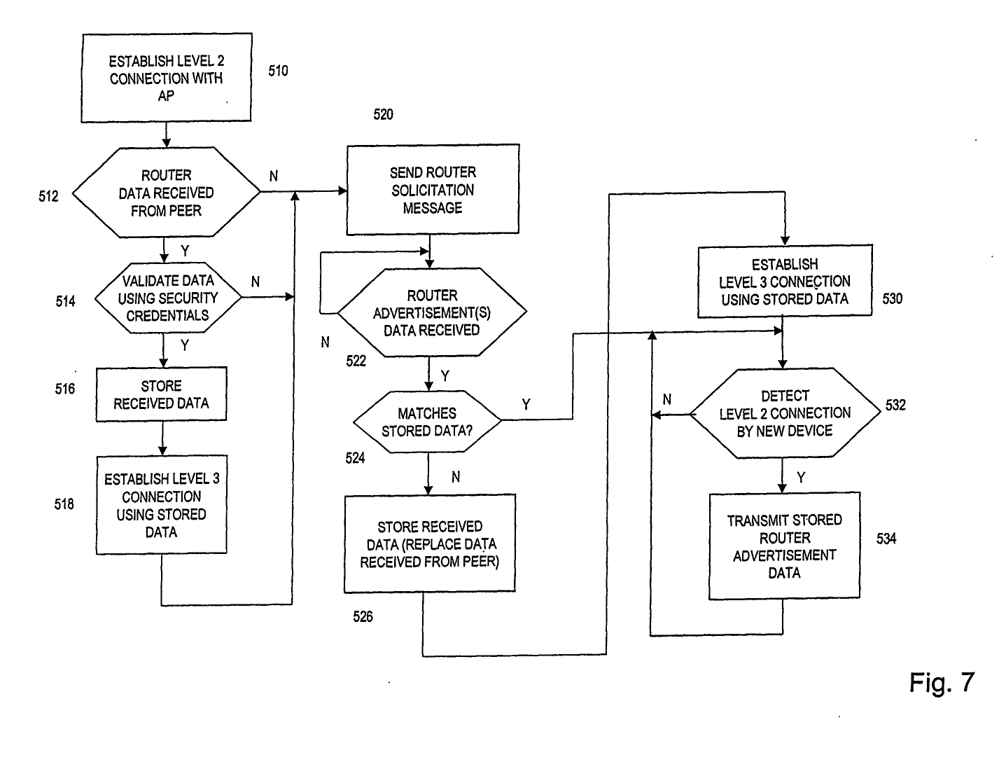

FIG. 7 illustrates another aspect of the invention; the establishment of a network layer or level 3 connection. The method shown in FIG. 7 may be used together with or separate from the methods described previously. At step 510, mobile device 104′ has just moved and has established a level 2 connection with access point 110, for example, by any of the methods described previously or shown in FIGS. 5A, 5B, 6A or 6B or by any other conventional method. Next, at step 512, mobile device 104′ determines if it has received router configuration data from another mobile device (not shown). If it has received the configuration data then, at step 514, mobile device 104′ checks the validity of the data, for example, by determining the validity of security credentials received with the data. If the data is valid the process stores the data at step 516 and establishes the level 3 connection at step 518 using the stored data. The mobile device may then immediately begin its application thread using this connection. If at step 512 the mobile device 104′ had not received router configuration data from a peer or if at step 514 the received data was found to be invalid then control is transferred to step 520 to send a router solicitation message.

After step 518, even though the level 3 connection has been established, the exemplary algorithm may branch to step 520 to send a router solicitation information. This optional step, and optional steps 522, 524, 526 and 530 may be done to ensure that any bad configuration data transmitted by a malicious peer is used only for a short time. After sending the router solicitation message, the connection thread of the mobile device 104′ waits at step 522 for router advertisement data. When the router advertisement data is received, it is checked, at step 524, against the data that was stored at step 516 (if any such data was stored). If the router advertisement data matches the stored data at step 524, control transfers to step 532, described below.

If, however, the data received at step 522 does not match the stored data then the new data is stored at step 526, replacing any configuration data that was received from the peer at step 512. After step 526, the process, at step 530 establishes a new level 3 connection using the received advertisement data.

At step 532, mobile device 104′ enters a loop in which it listens for any new devices establishing a level 2 connection with access point 110 and, when such a connection is detected, at step 534, device 104′ sends the stored router advertisement data. In the flow-chart diagram of FIG. 6, it is the data transmitted at step 624 by the other mobile device (not shown) that is received by the mobile device 104′ at step 612.

Upon detecting the level 2 connection at step 532, mobile device 104′ may wait a random amount of time before sending the router configuration data while monitoring the transmission channel. This random time interval avoids conflicts with transmissions by other mobile devices. If another mobile device (not shown) sends the router configuration data during this interval or if the router sends its router advertisement data, mobile device 104′ may abort its transmission. Additionally, access point 110 may designate one of one or more mobile devices on the network as being responsible for detecting level 2 connections at step 532 and transmitting the router configuration data in step 534. In such an embodiment, therefore, the random delay may be omitted, since there will only be one designated device responsible for transmitting router configuration data.

In one embodiment of the invention, level 2 and 3 connections and connection information conform to the IEEE 802.11 standard, whereby when a mobile device successfully initiates a level 2 connection with an access point, the mobile device attempts to authenticate/associate the access point. A request for authentication is sent from the mobile device to the access point, which replies with an association response. The association response sent by the access point is seen by all other mobile devices on the network, constituting the level 2 detection of step 522.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for hand-off of mobile devices between a plurality of access points comprising the steps of:
receiving, at a first mobile device, connection information for establishing a wireless connection between the mobile device and one of the plurality of access points;
storing the received connection information;
transmitting the stored connection information from the first mobile device to one or more other mobile devices to assist the one or more other mobile devices in making a connection to the access point.

2. A method according to claim 1, wherein the connection information is data link level connection information and the step of transmitting the stored information includes the step of periodically transmitting the connection information through a channel used by the first mobile device to communicate with a current access point.

3. A method according to claim 1, wherein the connection information is data link level connection information and the step of transmitting the stored information includes the step of periodically transmitting the connection information through a channel used by the first mobile device to communicate with a prior access point.

4. A method according to claim 1, further including the steps of:
establishing the wireless connection between the mobile device and the access point;
monitoring relative distance between the mobile device and the access point; and
establishing a new wireless connection between the mobile device and another one of the plurality of access points when the monitored distance between the mobile device and the access point becomes greater than a predetermined threshold value.

5. A method according to claim 1, further including the steps of:
establishing the wireless connection between the mobile device and the access point;
monitoring signal strength between the mobile device and the access point; and
establishing a new wireless connection between the mobile device and another one of the plurality of access points when signal strength becomes less than a predetermined threshold value.

6. A method according to claim 5, wherein the step of storing the information includes the steps of assigning a priority level to the information and storing the information to a list organized according to the priority level.

7. A method according to claim 5, wherein the step of establishing the new wireless connection includes the steps of retrieving the connection information having a highest priority level in the list and attempting to establish the new wireless connection according to the connection information having the highest priority level.

8. A method according to claim 1, wherein the step of transmitting the information includes the step of adjusting transmission power to increase or decrease coverage range according to predetermined criteria.

9. A method according to claim 1, wherein the connection information is network level connection information and the step of transmitting the connection information includes the steps of:
detecting when one or more mobile devices establish a data link level connection to the access point; and
transmitting the network level connection information to the one or more mobile devices.

10. A method for hand-off of mobile devices between a plurality of access points comprising the steps of:
receiving, at a first mobile device connected to a current access point, connection information for establishing a wireless connection between the mobile device and one or more of the plurality of access points;
storing the received connection information;
transmitting stored connection information to establish a wireless connection between the mobile device and one of the current access point and a prior access point from the first mobile device to one or more other mobile devices to assist the one or more other mobile devices in making a connection to the current or prior access points.

11. A method according to claim 10, wherein the step of transmitting stored connection information includes transmitting stored connection information for establishing a wireless connection to the prior access point through a channel used to communicate to the current access point.

12. A method according to claim 10, wherein the step of transmitting stored connection information includes transmitting stored connection information for establishing a wireless connection to the current access point through a channel used to communicate to the prior access point.

13. A method according to claim 10, wherein the step of storing received information the step of assigning a priority level to the information and storing the information to a list organized according to the priority level, the method further comprising the steps of:
monitoring signal strength between the first mobile device and the current access point; and
establishing a new wireless connection between the first mobile device and another one of the plurality of access points according to the received information having a highest priority level, when signal strength goes below a predetermined threshold value.

14. A method according to claim 10, wherein the step of storing received information the step of assigning a priority level to the information based on distance between the mobile device and each of the access points and storing the information to a list organized according to the priority level, the method further comprising the steps of:
monitoring relative distance between the first mobile device and each of the stored access points based on position information included with the stored access point information to maintain the priority list; and
establishing a new wireless connection between the first mobile device and another one of the plurality of access points according to the received information having a highest priority level, when signal strength goes below a predetermined threshold value.

15. A method according to claim 10, wherein the step of transmitting the information includes the step of adjusting transmission power to increase or decrease coverage range according to predetermined criteria.

16. A method for hand-off of mobile devices between a plurality of access points comprising the steps of:
receiving, at a first mobile device, network level connection information for establishing a level 3 connection between the mobile device and a current one of the plurality of access points;
storing the received network level connection information;
detecting when one or more mobile devices establish a data link level connection to the access point; and
transmitting the network level connection information from the first mobile device to one or more other mobile devices to assist the one or more other mobile devices in making a network level connection to the access point.
